(19) United States
(12) Patent Application Publication
(10) Pub. No.: US 2023/0120106 A1
(43) Pub. Date: Apr. 20, 2023

(54) HEAT, CORROSION, AND IMPACT RESISTANT, LIGHTWEIGHT, MASS-PRODUCIBLE, AND ANTIBACTERIAL INSULATION MATERIAL

(71) Applicant: Mustafa Tansel Tekin, South Hadley, MA (US)

(72) Inventor: Mustafa Tansel Tekin, South Hadley, MA (US)

(73) Assignee: BORTIGIN LLC, Indian Orchard, MA (US)

(21) Appl. No.: 17/624,310

(22) PCT Filed: Jun. 22, 2020
(86) PCT No.: PCT/TR2020/050532

§ 371 Date: Dec. 31, 2021

(30) Foreign Application Priority Data
Jun. 15, 2020 (TR) 2020/09188

(51) Int. Cl. C08K 3/015; C08J 3/20; C08K 3/26; B29C 70/88

(52) U.S. Cl. CPC C08K 3/015; B29C 70/88; C08J 3/203; C08K 3/26; C08K 2003/222

(57) ABSTRACT

The invention relates to a lightweight, mass-producible, antibacterial insulation material with high heat, corrosion and impact resistance that can be used in construction, machinery & equipment, furniture, defense, apparel-accessory industry, art, as well as in land-sea-air vehicles.

### TECHNICAL FIELD OF THE INVENTION

The invention relates to a lightweight, mass-producible, antibacterial insulation material with high heat, corrosion and impact resistance that can be used in construction, machinery & equipment, furniture, defense, apparel-accessory industry, art, as well as in land-sea-air vehicles.

### BACKGROUND OF THE ART

Currently, insulation materials that are made from different substances are used for various industrial purposes. In general, we can classify these insulation materials into three categories.

The first of these categories is the iron-steel and metal alloy insulation products. The most important disadvantages of these insulation materials can be listed as being heavy, unprotected against corrosion (low resistance to corrosion), difficult maintenance and having very high cost of recycling.

The second product group of insulation materials is wood insulation products. The most important disadvantages of these type of insulation materials can be listed as being unprotected against corrosion (low resistance to corrosion), being open to bacterial growth since they house bacteria, and having very low heat resistance.

The third product group of existing insulation materials is insulation materials produced from plastic and plastic derivatives. Insulation materials made from plastic and its derivatives have very low heat and impact resistance. In addition, these materials are open to bacterial growth and house bacteria.

While no patent similar to the invention is found in the patent search conducted; TR2015 / 11580 is about borax-containing low-density granular detergent (and its production method ) which does not contain harmful chemicals, does not contain phosphates, does not pose a threat to human health and ecological balance, does not cause environmental pollution, and can be used for laundry and dishes.

European Patent numbered as EP2398863B1 is about fusion-bonded epoxy coating compositions that include magnesium oxide. Coating is described as follows: from about 50 wt% to about 90 wt% of at least one epoxy resin; (b) from about 1 wt% to about 30 wt% of at least one catecholnovolak-type adhesion promoter; and (c) from about 0.1 wt% to about 5 wt% of magnesium oxide. In another aspect, the coating composition can further comprise from about 10 wt% to about 48 wt% of an inorganic filler material. Exemplary embodiments of the coating composition provide improved adhesion at high temperature operating conditions and improved resistance to damage by cathodic disbondment for pipe, rebar, and other substrates.

### OBJECT OF THE INVENTION

The main object of the invention is to develop lightweight, mass-producible, antibacterial insulation material with high heat, corrosion and impact resistance that can be used in construction, machinery & equipment, furniture, defense, apparel-accessory industry, art, as well as in land-sea-air vehicles.

Another object of the invention is to develop an insulation material that can be produced easily without any need of high temperatures.

Yet another object of the invention is to develop an insulation material that can be used as a flame-retardant and has a high heat resistance.

Yet another object of the invention is to develop a lightweight insulation material compared to metal, wood and plastic based insulation materials. Compared to other existing impact-resistant materials of the same size/measurements, this invention can provide same or better durability as a lightweight product.

The following technical advantages are obtained with this invention:
The product is a lightweight product.
It has high heat resistance.
The product of the invention is antibacterial.
The material is liquid-proof.
It has high corrosion resistance.
The product of the invention is also over 95% recyclable. Therefore, it is an environmentally friendly product compared to other insulation materials.
The product of the invention can be produced as a conductor or insulator.

In summary, to be used in construction, machinery & equipment, furniture, defense, apparel-accessory industry, art, as well as in land-sea-air vehicles; this heat, corrosion and impact resistant, lightweight, mass-producible, and antibacterial insulation material has been developed, comprising:
Acrylic Resin
Fabric
Borax
Magnesium Oxide
Sodium Bicarbonate

An insulation material production method has also been developed and comprises the following steps:
Making a mixture using acrylic group resins,
Adding borax, magnesium oxide and sodium bicarbonate into this mixture to obtain the final mixture,
Treating the final mixture obtained on fabric,
Giving the desired form to the product, blowing air on the mixture-treated fabric until it hardens, and leaving the product to rest.

### DETAILED DESCRIPTION

The invention is a lightweight, mass-producible, antibacterial insulation material with high heat, corrosion and impact resistance that can be used in construction, machinery & equipment, furniture, defense, apparel-accessory industry, art, as well as in land-sea-air vehicles.

The insulation material comprises:
Acrylic Resin
Fabric
Borax
Magnesium Oxide
Sodium Bicarbonate

The method of production for the insulation material is as follows: Adding borax, magnesium oxide and sodium bicarbonate into the acrylic group resin mixture, treating this mixture on the fabric, giving the desired form to the product, blowing 22-24° C. air to the product until it hardens, and then leaving the product to rest for 24 hours.

Alternatively, the insulation material can be painted with a desired color. Optionally, the subject matter invention can be coated with sand, natural stones, etc.

An alternative method of production of the invention is the casting method. This method comprises the following steps: After adding borax, magnesium oxide and sodium bicarbonate into the acrylic group resin mixture, the mixture is poured into a mold. The mixture is then dried until it hardens. Drying time varies based on the thickness of the invention material. Optionally in this method; paint, sand, natural materials, stones, powdered ceramics, metals etc. can be added directly to the mixture before pouring the mixture into the mold. Alternatively, paint, sand, natural materials, stones, powdered ceramics, metals, etc. can be placed in the mold first and the acrylic resin and borax, magnesium oxide and sodium bicarbonate mixture can be poured into the mold.

The product of the invention can also be used for local repair or coating.

Since the invention has high viscosity, it can also be used for bonding and fusion purposes.

The invention in question can also be used in the agricultural environment. It can be used as equipment in insulation rooms/warehouses, product transport containers and agricultural machinery.

1. A lightweight, mass-producible, antibacterial insulation material with high heat, corrosion and impact resistance that can be used in construction, machinery & equipment, furniture, defense, apparel-accessory industry, art, as well as in land-sea-air vehicles, comprising:
Acrylic Resin
Fabric
Borax
Magnesium Oxide
Sodium Bicarbonate.

2. A method of production for a lightweight, mass-producible, antibacterial insulation material with high heat, corrosion and impact resistance that can be used in construction, machinery & equipment, furniture, defense, apparel-accessory industry, art, as well as in land-sea-air vehicles, comprising the steps of;
Making a mixture using acrylic group resins,
Adding borax, magnesium oxide and sodium bicarbonate into this mixture to obtain the final mixture,
Treating the final mixture obtained on fabric,
Giving the desired form to the product, blowing air on the mixture-treated fabric until it hardens, and leaving the product to rest.

3. The method of production for the insulation material according to claim 2, in which the air blown on the mixture-treated fabric is in the range of 22-24° C.

4. The method of production for the insulation material according to claim 2, in which the product is left to rest for 24 hours after blowing the air on the treated fabric.

5. The method of production for the insulation material according to claim 2, in which the insulation material can be painted in a desired color.

6. The method of production for the insulation material according to claim 2, wherein the insulation material can be coated with any material like sand, natural stones etc.

7. The method of production for a lightweight, mass-producible, antibacterial insulation material with high heat, corrosion and impact resistance that can be used in construction, machinery & equipment, furniture, defense, apparel-accessory industry, art, as well as in land-sea-air vehicles, comprising:
Making a mixture using acrylic group resins,
Adding borax, magnesium oxide and sodium bicarbonate into this mixture to obtain the final mixture,
Pouring the mixture into a mold,
Drying the mixture in the mold until it hardens.

8. The method of production for the insulation material according to claim 7, in which paint, sand, natural materials, stones, powdered ceramics, metals, etc. can be added directly to the mixture before pouring the mixture into the mold.
